(19) United States
(12) Patent Application Publication
(10) Pub. No.: US 2025/0200628 A1
(43) Pub. Date: Jun. 19, 2025

(54) PRODUCT ALTERNATIVE INJECTION BASED ON VALUE PROPOSITION

(71) Applicant: INTERNATIONAL BUSINESS MACHINES CORPORATION, Armonk, NY (US)

(72) Inventors: Logan Bailey, Atlanta, GA (US); Zachary A. Silverstein, Georgetown, TX (US); Jeremy R. Fox, Georgetown, TX (US); Jessica Nahulan, Markham (CA)

(21) Appl. No.: 18/538,604

(22) Filed: Dec. 13, 2023

(51) Int. Cl. G06Q 30/0601; G06F 40/40; G06Q 10/20

(52) U.S. Cl. CPC G06Q 30/0629; G06F 40/40; G06Q 10/20; G06Q 30/0631; G06Q 30/0633

(57) ABSTRACT

A computer-implemented method may include: identifying a replacement component for a device component; performing, by a regression model, predictive analysis on user input data to identify a root cause that the device component would need to be replaced; generating, by large language model processing, one or more replacement subsets or one or more replacement supersets, wherein the one or more replacement subsets or one or more replacement supersets each correspond to the replacement component; determining device maintenance metrics over time corresponding to the replacement component and the one or more replacements subsets and the replacement supersets; and in response to determining device maintenance metrics over time, communicating a ranked list of product alternatives.

### BACKGROUND

Aspects of the present invention relate generally to computerized systems and methods for determining purchase alternatives.

Identifying suitable alternatives when purchasing, e.g., device components, requires an in-depth analysis with respect to cost, component lifespan, ease-of-repair, and consideration of efficiencies with respect to purchased components and replacing existing components. In particular, replacing existing components may be affected by other factors than simple component replacement.

### SUMMARY

In a first aspect of the invention, there is a computer-implemented method including: identifying, by a processor set, a replacement component for a device component; performing, by the processor set using a regression model, predictive analysis on user input data to identify a root cause that the device component would need to be replaced; generating, by the processor set using a large language model processing, one or more replacement subsets or one or more replacement supersets, wherein the one or more replacement subsets or one or more replacement supersets each correspond to the replacement component; determining, by the processor set, device maintenance metrics over time corresponding to the replacement component and the one or more replacements subsets and the replacement supersets; and in response to determining device maintenance metrics over time, communicating, by the processor set, a ranked list of product alternatives.

In another aspect of the invention, there is a computer program product including one or more computer readable storage media having program instructions collectively stored on the one or more computer readable storage media. The program instructions are executable to: identify a replacement component for a device component; perform, by a regression model, predictive analysis on user input data to identify a root cause that the device component would need to be replaced; generate, by large language model processing, one or more replacement subsets or one or more replacement supersets, wherein the one or more replacement subsets or one or more replacement supersets each correspond to the replacement component; determine device maintenance metrics over time corresponding to the replacement component and the one or more replacements subsets and the replacement supersets; and in response to determining device maintenance metrics over time, communicate a ranked list of product alternatives.

In another aspect of the invention, there is a system including a processor set, one or more computer readable storage media, and program instructions collectively stored on the one or more computer readable storage media. The program instructions are executable to: identify a replacement component for a device component; perform, by a regression model, predictive analysis on user input data to identify a root cause that the device component would need to be replaced; generate, by large language model processing, one or more replacement subsets or one or more replacement supersets, wherein the one or more replacement subsets or one or more replacement supersets each correspond to the replacement component; determine device maintenance metrics over time corresponding to the replacement component and the one or more replacements subsets and the replacement supersets; and in response to determining device maintenance metrics over time, communicate a ranked list of product alternatives.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

### DETAILED DESCRIPTION

Aspects of the present invention relate generally to utilizing user search data and search metadata relating to determining product alternatives, such as repair components for devices in need of repair or replacement and, more particularly, to determining alternative products or components suitable for devices in need of repair or replacement based on repair component costs, repair time, installation time, repair time, and installation difficulty. According to aspects of the present invention, user search queries, user purchase research, and user purchase attempts relating to components are used to determine alternative components suitable for a task or repair. In embodiments, replacement component supersets, i.e., sets of replacement components making up a larger, replaceable assembly including the specific component to be repaired or replaced may be suitable for a task or repair because they replace an assembly including a component in need of replacement or repair. For example, a component superset may include the component to be replaced as well as additional components making up a larger assembly. Similarly, replacement component subsets, i.e., smaller sets of replacement components that make up a portion of a specific component to be repaired or replaced may be suitable for a task or repair because they may be used to replace a component in need of replacement or repair without replacing or repairing a larger assembly. For example, a component subset may include only portions of the component to be replaced and not additional components making up a larger assembly. In embodiments, alternative components may be one-to-one replacements for a component, though alternative components may not necessarily be identical to the component being replaced. In embodiments, device maintenance metrics, such as cost, repair time, installation time, repair time, and installation difficulty, may be determined over time and compared using the replacement component, replacement component supersets, and replacement component subsets to determine a ranked list of replacement component alternatives. In this manner, implementations of the invention process a user intended product purchase based on search data and product metadata, determine alternative products for purchase, and prompt a user with product alternatives and relevant information comparing the intended product purchase to alternatives.

In embodiments, a computer-implemented method and system for optimizing the replacement of device components, including identifying, based on a user search query, a replacement component for a device component; determining, based, at least in part, on the replacement component for the device component, one or more potential reasons that the device component would need to be replaced; identifying, based on the one or more potential reasons that the device component would need to be replaced, one or more replacement subsets or replacement supersets associated with the replacement component; comparing device maintenance metrics between the one or more replacements subsets or replacement supersets and the replacement component; and presenting, via a user interface, a ranking of the replacement component, the one or more replacement subsets, and the one or more replacement supersets for the device based on an optimization of the device maintenance metrics over time.

In embodiments, a computer-implemented method and system as previously described may include comparing metrics between the replacement component and one or more alternative replacement components that are compatible with the device component; and presenting, via the user interface, an additional ranking including of the replacement component and the one or more alternative replacement components based on an optimization of the device maintenance metrics over time.

In known systems, product or component identification, purchase, replacement, or repair may be time-consuming, costly, and inefficient if unidentified alternative components are available at a lower cost or with higher ease of repair or replacement. In known systems, a purchaser may find it difficult to reliably source components with a desirous cost, efficacy, and ease of repair or replacement due to the vast volume of suitable replacement components, component supersets, and component subsets. For example, in known systems, a three-dimensional (3D) printing warehouse that produces large quantities of products for other industries may encounter the fragility of 3D printers, such as the fragility of 3D printer components, 3D printer component supersets, and 3D printer component subsets. In this example, replacing 3D printer components, supersets, and subsets may create unsustainably high repair costs and manufacturing downtime. For example, in known systems, a three-dimensional (3D) printing warehouse may encounter recurring failures of various components within a 3D printer head, such as a nozzle or heatsink. Finding replacement nozzles or heatsinks that fit the specific 3D printer head in known systems may be time-consuming, costly, and inefficient compared to purchasing entire 3D printer head supersets available at a better cost while also being easier to replace and more reliable. In another example, it may be more efficient for the 3D printing warehouse to replace entire printer heads if only a nozzle malfunctions, as the cost and time to replace nozzles outweigh the efficiency of replacing printer heads, even at higher printer head costs than nozzles alone.

In embodiments, a computer-implemented method and system as previously described may include identifying a replacement component; generating one or more replacement subsets or one or more replacement supersets corresponding to the replacement component based on user product search data and product metadata; determining device maintenance metrics over time between the replacement component and the one or more replacements subsets or the replacement supersets based on option-time alternative analysis that considers the cost, efficacy, and ease of repair or replacement; and in response to determining device maintenance metrics over time, communicating a ranked list of product alternatives.

In embodiments, the computer-implemented method and system may also include determining one or more potential reasons, through root cause analysis of why a particular component may require repair or replacement through machine learning processing of user data selected from a group consisting of a user search query, user purchase research, user purchase attempt, a third-party search query, a third-party purchase research, and a third-party purchase attempt corresponding to a replacement component. Machine learning (ML) processing may include generative pretrained transformative models, large language models (LLM), or bidirectional encoder representations from transformers, or regression models. However, ML is not limited to these examples, and may include other models.

In embodiments, the computer-implemented method and system may also include machine learning processing and iterative improvement of product information stored in a database based on user search query, user purchase research, user purchase attempt, a third-party search query, a third-party purchase research, and a third-party purchase attempt corresponding to a replacement component. In an example, LLM processing of product information stored in a database may improve recommendations for replacement components, replacement component supersets, and replacement component subsets to determine a ranked list of replacement component alternatives. Large language model (LLM) processing may be trained on text data relating to replacement components, supersets, and subsets as well as text data relating to root causes to determine relationships between the two. Additionally, the LLM may be tuned to exclude certain text data or prefer certain text data relating to replacement components and root causes. In this way, the LLM may analyze relationships between words, sentences, and context to generate predictive responses to user input. The LLM may generate recommendations based on the most likely sequence of words and sentences based on user input and LLM stored data. Additionally, an LLM with an attention layer or attention mechanism may be utilized to further focus the LLM on specific portions of user input to generate more relevant product alternative recommendations.

The system may also use machine learning models to associate product purchases with specific root causes based on root cause analysis. In an example, the system may utilize regression models to perform predictive analysis on user input data to identify root causes of specific problems in the context of the user input. The system may also use machine learning models to correlate alternative replacement components to replacement components based on identification of a root cause. In an example, the system may utilize a regression model to predict the root cause of the need to replace a component, such as a 3D printer nozzle experiencing frequent clogging. In this example, user search queries of “replacement 3D printer nozzles” may be input into a regression model or generative pretrained transformative model which may identify similar third-party search query data that may be associated with previous product recommendations, or search queries relating to a particular product, such as queries based on web cookies, “how-to” instructions or instructional videos, previous searches at e-commerce websites, or web-based navigation relating to a product or particular problem relating to the product. For example, search query data may include information relating to searching for instructional how-to replacement videos for nozzles of a 3D printer. The computer implemented method and system may retrieve metadata on the product searched for in these search queries from a commercial hierarchy product database. The commercial hierarchy product database may be predefined or learned based on product search queries including historical user navigation, a third-party search query and navigation relating to root causes, product supersets and subsets, pricing, and option-time alternatives. The computer implemented method and system may perform root cause analysis using search queries and product metadata to generate potential issues or problems that a user is attempting to fix or repair, such as search queries for “how to fix broken 3D printer nozzle?” Root causes may be identified based on the most frequently known predefined root causes or through generative pretrained transformative model processing, large language models, bidirectional encoder representations from transformers, or regression models. Based on the root cause analysis, the computer implemented method and system may identify candidate products to address the root cause. Alternative products may also be retrieved and analyzed to determine device maintenance metrics over time including expectations of repair time, install time, or overall interaction time of a user when replacing a product or solving the root cause. Device maintenance metrics may be determined over time including expectations of repair time, install time, or overall interaction time based on analysis of product information, user comments or reviews relating to products, product manuals or installation data, an instructional video or tutorial data, including associated metadata. In embodiments, device maintenance metrics may include item price and optimization information to demonstrate incremental value increases over alternative replacement products, supersets, or subsets. In embodiments, device maintenance metrics may be optimized by updating products, supersets, and subsets data relating to price, difficulty to replace, lifetime, or the like.

Implementations of the invention are necessarily rooted in computer technology. For example, the steps of generating, by the processor set using a large language model processing, one or more replacement subsets or one or more replacement supersets each corresponding to the replacement component, performing, by the processor set using a regression model, predictive analysis on user input data to identify a root cause that the device component would need to be replaced, and performing, by the processor set using a generative pretrained transformative model, predictive analysis on user data selected from a group consisting of a user search query, a user purchase research, and a user purchase attempt to identify a root cause that the device component would need to be replaced are computer-based and cannot be performed in the human mind. Training and using a machine learning model are, by definition, performed by a computer and cannot practically be performed in the human mind (or with pen and paper) due to the complexity and massive amounts of calculations involved. For example, a generative pretrained transformative model processing, large language models, bidirectional encoder representations from transformers, or regression models may have millions or even billions of weights within the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, user search data and metadata), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as product alternative injection code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

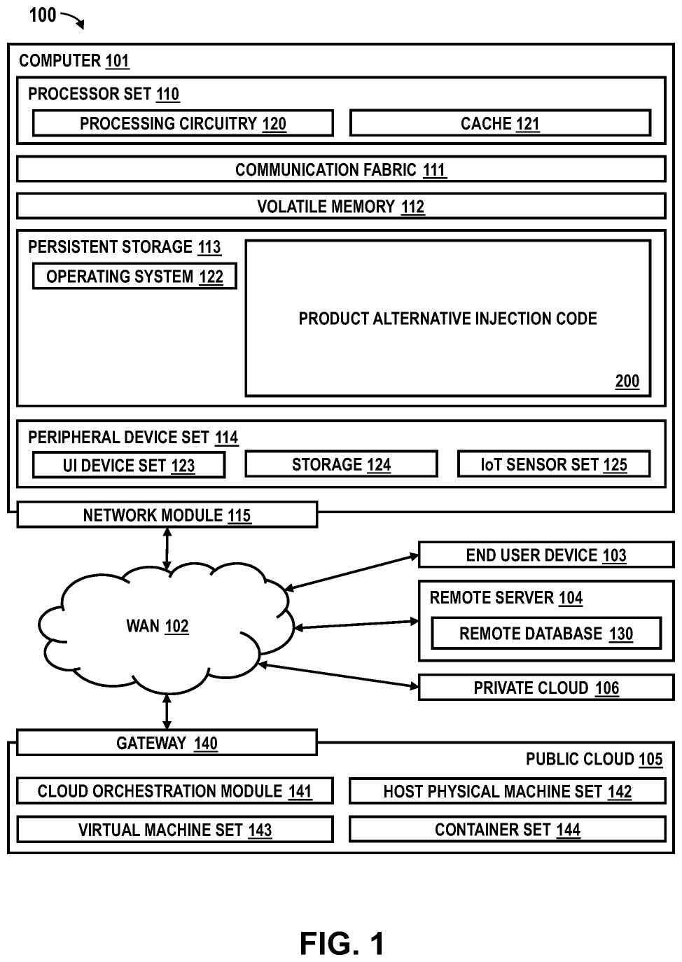

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

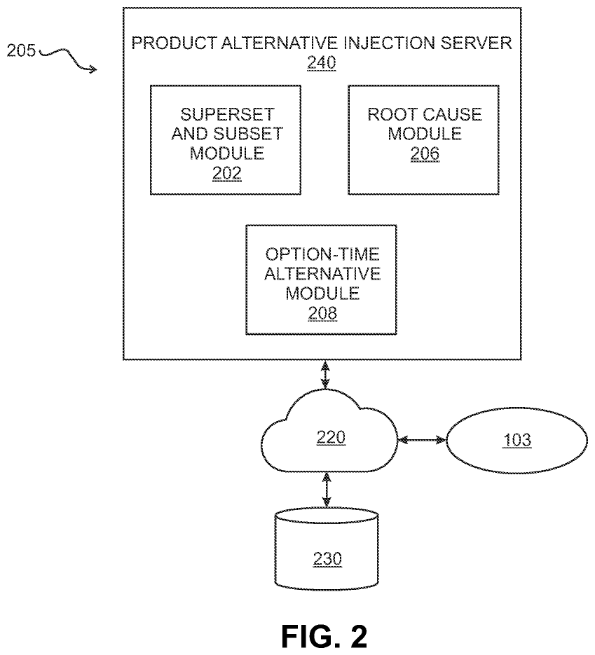

FIG. 2 shows a block diagram of an exemplary environment 205 in accordance with aspects of the invention. In embodiments, the environment includes product alternative injection server 240, corresponding to computer 101 of FIG. 1, including or in communication with superset and subset module 202, root cause module 206, and option-time alternative module 208, collectively corresponding to product alternative injection code of block 200, as in FIG. 1. The product alternative injection server 240 includes or is in communication with the superset and subset module 202, root cause module 206, and option-time alternative module 208 for performing product superset and subset determination, root cause analysis, and option-time alternative analysis. The environment 205 also includes at least one database 230 in operable communication with the product alternative injection server 240 over network 220, corresponding to WAN 102 of FIG. 1. The database 230, corresponding to remote server 104 or remote database 130 of FIG. 1, may store product data including superset and subset product data, user search query data, root cause data, and option-time alternative analysis data, among other things. EUD 103, corresponding to EUD 103 of FIG. 1, may be in operable communication with the product alternative injection server 240 over the network 220, to allow users to opt-in to thane system and method.

In embodiments, the product alternative injection server 240 of FIG. 2 comprises superset and subset module 202, root cause module 206, and option-time alternative module 208, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The product alternative injection server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

The superset and subset module 202 may identify the replacement components based on user data selected from a group consisting of a user search query, a user purchase research, and a user purchase attempt corresponding to the replacement component for a device. Alternatively, root cause module 206 may identify the replacement components based on feedback and consensus from historical user reviews of the replacement component. The superset and subset module 202 may generate one or more replacement subsets or one or more replacement supersets based on one or more potential reasons (e.g., root causes) identified by the root cause module 206. Additionally, superset and subset module 202 may identify one or more complimentary components based on the one or more replacement subsets or one or more replacement supersets and in response to identifying one or more complimentary components and communicating a recommendation of the one or more complimentary components.

The root cause module 206 may identify root causes by determining one or more potential reasons that the device component would need to be replaced based on the replacement component, such as common failure points or component failure reasons. Alternatively, root cause module 206 may identify root causes by determining the one or more potential reasons through generative pretrained transformative models or large-language model processing of user data selected from a group consisting of a user search query, a user purchase research, and a user purchase attempt corresponding to the replacement component for a device.

The option-time alternative module 208 may determine device maintenance metrics over time corresponding to the replacement component and the one or more replacements subsets or the replacement supersets device maintenance metrics. Device maintenance may include metrics selected from a group consisting of cost, repair time, installation time, repair time, and installation difficulty. Device maintenance metrics may be determined based on user feedback and consensus from historical user reviews of a component, repair or replacement tutorials, etc.

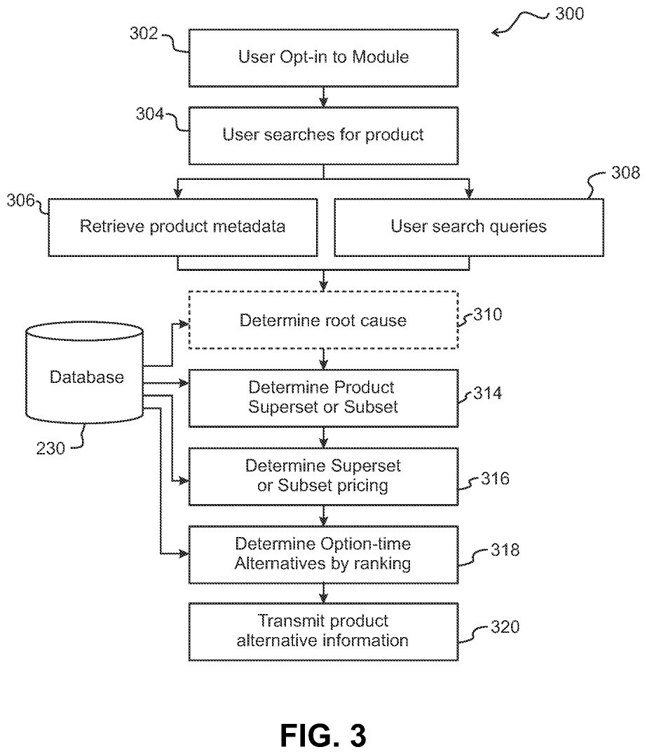

FIG. 3 shows a flowchart of an exemplary method in accordance with aspects of the present invention. Steps of the method may be carried out in the environment of FIG. 2 and are described with reference to elements depicted in FIG. 2. At step 302, the system 300 may receive user opt-in or consent to permit the system to retrieve or collect user search query data and metadata during operation. In embodiments, and as described with respect to FIG. 2, a user may opt-in via EUD 103 as in FIG. 1 or 103EUD 103 as in FIG. 2. At step 304, a user may search for a product, such as a replacement part, and the system may retrieve and store product metadata 306 relating to the product, as well as retrieve and store user search queries 308. In this way, the system may identify a replacement component for a device component or generate one or more replacement subsets or one or more replacement supersets via the superset and subset module 202 as in FIG. 2. In embodiments, the system may identify replacement component(s) based on feedback and consensus from historical user reviews of the replacement component via the superset and subset module 202 as in FIG. 2. Product metadata 306 and user search queries 308 may be correlated to one another, such as by associating search frequency data with product purchase frequency data to identify search-to-purchase ratios and frequency of purchasing or re-purchasing of a particular product. Similarly, product metadata 306 and user search queries 308 may be correlated to one another by associating the frequency of purchasing or re-purchasing of a particular product with respect to a product alternative to identify the frequency at which users may purchase multiple, alternative products. At step 310, the system may determine a root cause, via root cause analysis performed by the root cause module 206 of FIG. 2, using search queries and product metadata to generate potential issues or problems that a user is attempting to fix or repair relating to the searched-for product. In embodiments, step 310 may be an optional step. Root causes may be determined via a regression model or large-language model processing of user data selected from a group consisting of a user search query, a user purchase research, and a user purchase attempt corresponding to the replacement component for a device component. Root causes may include one or more potential reasons that the device component would need to be replaced based on the identified replacement component. Root causes may be identified based on the most frequently known predefined root causes (based on product metadata or through generative pretrained transformative model processing, large language models, bidirectional encoder representations from transformers, or regression models). Root cause analysis may rely on information stored by and retrieved from database 230. which may be the commercial hierarchy product database which is predefined or learned based on product search queries, historical user navigation, or third-party search queries and navigation relating to root causes, product supersets and subsets, pricing, and option-time alternatives. Root cause identification may facilitate the determination of product supersets and subsets, as in step 314, based on one or more potential reasons that the device component would need to be replaced. In embodiments, in step 314, root cause analysis may not be performed, and the system may directly determine product supersets and subsets via the superset and subset module 202 of FIG. 2, based on product metadata 306 and user search queries 308 correlated to one another. In embodiments, the system may also identify one or more complimentary components based on the one or more replacement subsets or one or more replacement supersets associated with the replacement component. In step 316, product superset and subset pricing data may be determined and compared to the pricing of a product that was searched. Pricing data may be retrieved from database 230 or retrieved from product data available over WAN 102, of FIG. 1 or network 220 of FIG. 2. In step 318, option-time alternative analysis may determine, via the option-time alternative module 208 of FIG. 2, the cost, efficacy, and ease of repair or replacement of a product with respect to product alternatives, product supersets, or product subsets. For example, option-time alternative analysis may provide pricing, difficulty to replace, and product lifetime information for a searched-for product, an alternative product, a superset product containing the searched-for product, or a subset product that addresses the identified root cause of a problem. As another example, option-time analysis may include determining device maintenance metrics over time corresponding to a replacement component and one or more replacements subsets or the replacement supersets including cost, repair time, installation time, repair time, and installation difficulty. Option-time alternative analysis and device maintenance metrics may include ranking, such as a list of products, product alternatives, supersets, and subsets based on price, difficulty to replace, product lifetime, or the like to facilitate informed purchasing by a user. In step 320, the system may transmit product alternative information or complimentary component information to a user interface of a user device, such as EUD 103 of FIG. 1 or EUD 103 of FIG. 2, for display and use by a user. In embodiments, the system may communicate ranked lists of product alternatives including one or more product alternatives selected from a group consisting of the replacement component, the one or more replacement subsets, and the one or more replacement supersets.

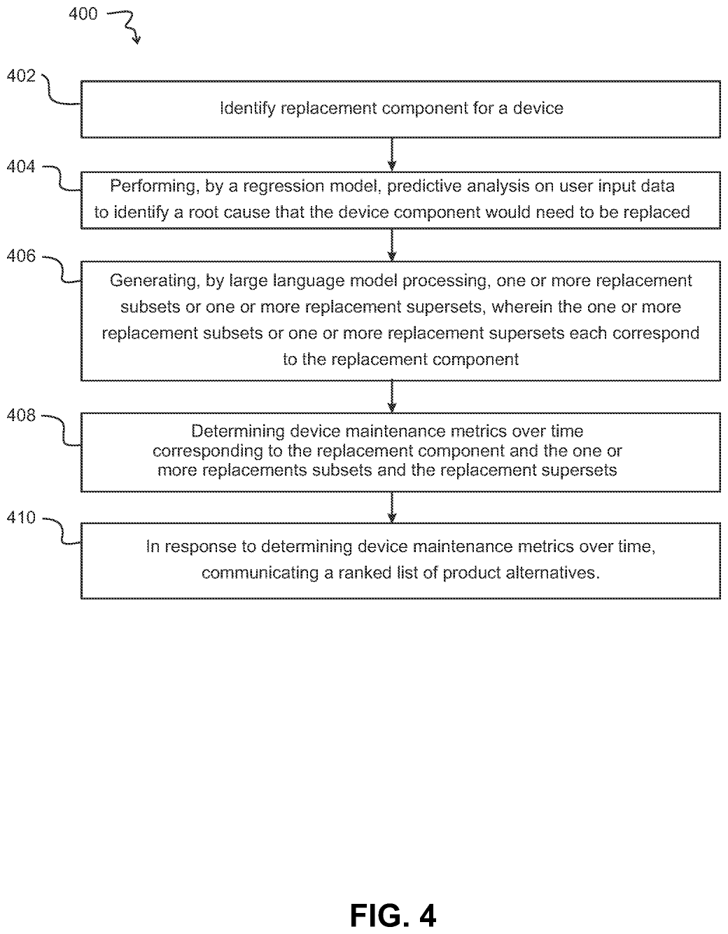

FIG. 4 shows a flowchart of an exemplary method in accordance with aspects of the present invention. Steps of the method may be carried out in the environment of FIG. 2 and are described with reference to elements depicted in FIG. 2. At step 402, the system 400, corresponding to system 300 depicted in FIG. 3, may identify, by a processor set, a replacement component for a device component via the superset and subset module 202 as in FIG. 2. In step 404, the system 400 may perform, by a regression model, predictive analysis on user input data to identify a root cause that the device component would need to be replaced. In step 406, the system 400 may generate one or more replacement subsets or one or more replacement supersets, wherein the one or more replacement subsets or one or more replacement supersets each correspond to the replacement component, such as via an LLM or the superset and subset module 202 as in FIG. 2. In step 408, the system 400 may determine device maintenance metrics over time, via the option-time alternative module 208 as in FIG. 2, corresponding to the replacement component and the one or more replacements subsets and the replacement supersets. In step 410, the system 400 may, in response to determining device maintenance metrics over time, communicate a ranked list of product alternatives via the product alternative injection server 240 as in FIG. 2.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, by a processor set, a replacement component for a device component;
performing, by the processor set using a regression model, predictive analysis on user input data to identify a root cause that the device component would need to be replaced;
generating, by the processor set using large language model processing, one or more replacement subsets or one or more replacement supersets, wherein the one or more replacement subsets or one or more replacement supersets each correspond to the replacement component;
determining, by the processor set, device maintenance metrics over time corresponding to the replacement component and the one or more replacements subsets and the replacement supersets; and
in response to determining device maintenance metrics over time, communicating, by the processor set, a ranked list of product alternatives.

2. The computer-implemented method as in claim 1, wherein the ranked list of product alternatives comprises one or more product alternatives selected from a group consisting of the replacement component, the one or more replacement subsets, and the one or more replacement supersets.

3. The computer-implemented method as in claim 1, wherein the identifying the replacement component occurs based on user data selected from a group consisting of a user search query, a user purchase research, and a user purchase attempt, wherein the user data corresponds to the replacement component for a device.

4. The computer-implemented method as in claim 1, wherein the identifying the replacement component occurs based on feedback and consensus from historical user reviews of the replacement component.

5. The computer-implemented method as in claim 1, wherein the device maintenance metrics are selected from a group consisting of expectations of repair time, install time, and overall interaction time of a user.

6. The computer-implemented method as in claim 1, further comprising:
performing, by the processor set using a generative pretrained transformative model, predictive analysis on user data selected from a group consisting of a user search query, a user purchase research, and a user purchase attempt to identify a root cause that the device component would need to be replaced.

7. The computer-implemented method as in claim 6, wherein the generating the one or more replacement subsets or the one or more replacement supersets occurs based on the root cause.

8. The computer-implemented method as in claim 1, further comprising:
identifying, by the processor set, one or more complimentary components based on the one or more replacement subsets or the one or more replacement supersets; and
in response to identifying the one or more complimentary components, communicating, by the processor set, a recommendation of the one or more complimentary components.

9. The computer-implemented method as in claim 1, wherein the device maintenance metrics comprise metrics selected from a group consisting of cost, repair time, installation time, repair time, and installation difficulty.

10. A computer program product comprising one or more computer readable storage media having program instructions collectively stored on the one or more computer readable storage media, the program instructions executable to:
identify a replacement component for a device component;
perform, by a regression model, predictive analysis on user input data to identify a root cause that the device component would need to be replaced;
generate, by large language model processing, one or more replacement subsets or one or more replacement supersets, wherein the one or more replacement subsets or one or more replacement supersets each correspond to the replacement component;
determine device maintenance metrics over time corresponding to the replacement component and the one or more replacements subsets and the replacement supersets; and
in response to determining device maintenance metrics over time, communicate a ranked list of product alternatives.

11. The computer program product as in claim 10, wherein the ranked list of product alternatives comprises one or more product alternatives selected from a group consisting of the replacement component, the one or more replacement subsets, and the one or more replacement supersets.

12. The computer program product as in claim 10, wherein the identifying the replacement component occurs based on user data selected from a group consisting of a user search query, a user purchase research, and a user purchase attempt, wherein the user data corresponds to the replacement component for a device.

13. The computer program product as in claim 10, wherein the identifying the replacement component occurs based on feedback and consensus from historical user reviews of the replacement component.

14. The computer program product as in claim 10, wherein the device maintenance metrics are selected from a group consisting of expectations of repair time, install time, and overall interaction time of a user.

15. The computer program product as in claim 10, further comprising program instructions executable to:
perform, by a generative pretrained transformative model, predictive analysis on user data selected from a group consisting of a user search query, a user purchase research, and a user purchase attempt to identify a root cause that the device component would need to be replaced.

16. The computer program product as in claim 15, wherein the generating the one or more replacement subsets or the one or more replacement supersets occurs based on the root cause.

17. The computer program product as in claim 10, further comprising program instructions executable to:
identify one or more complimentary components based on the one or more replacement subsets or the one or more replacement supersets; and
in response to identifying the one or more complimentary components, communicating a recommendation of the one or more complimentary components.

18. The computer program product as in claim 10, wherein the device maintenance metrics comprise metrics selected from a group consisting of cost, repair time, installation time, repair time, and installation difficulty.

19. A system comprising:
a processor set, one or more computer readable storage media, and program instructions collectively stored on the one or more computer readable storage media, the program instructions executable to:
identify a replacement component for a device component;
perform, by a regression model, predictive analysis on user input data to identify a root cause that the device component would need to be replaced;
generate, by large language model processing, one or more replacement subsets or one or more replacement supersets, wherein the one or more replacement subsets or one or more replacement supersets each correspond to the replacement component;
determine device maintenance metrics over time corresponding to the replacement component and the one or more replacements subsets and the replacement supersets; and
in response to determining device maintenance metrics over time, communicate a ranked list of product alternatives.

20. The system as in claim 19, further comprising program instructions executable to:
perform, by a generative pretrained transformative model, predictive analysis on user data selected from a group consisting of a user search query, a user purchase research, and a user purchase attempt to identify a root cause that the device component would need to be replaced.
